(19) United States
(12) Patent Application Publication
(10) Pub. No.: US 2026/0219622 A1
(43) Pub. Date: Jul. 30, 2026

(54) IMAGE FORMING SYSTEM, IMAGE FORMING APPARATUS, AND INFORMATION PROCESSING APPARATUS

(71) Applicant: CANON KABUSHIKI KAISHA, Tokyo (JP)

(72) Inventors: HIROKI KATO, Shizuoka (JP); MASATOSHI YOSHIDA, Shizuoka (JP); TAKASHI KUWATA, Shizuoka (JP)

(21) Appl. No.: 19/461,508

(22) Filed: Jan. 27, 2026

(30) Foreign Application Priority Data
Jan. 29, 2025 (JP) 2025-013042

(51) Int. Cl. G03G 15/00; G03G 15/01; G03G 15/16; G03G 21/16

(52) U.S. Cl. CPC G03G 15/5079; G03G 15/1605; G03G 15/1685; G03G 15/55; G03G 15/80; G03G 21/1633; G03G 15/0131; G03G 15/0189

(57) ABSTRACT

An image forming system that includes an image forming apparatus, a notification apparatus, and an information processing apparatus is disclosed. In a case where first information changes so as to exceed a threshold between a first point in time and a second point in time after the first point in time and there is an opening or closing log of a door in second information between the first point in time and the second point in time, the information processing apparatus notifies the notification apparatus of information about an installation state of a transfer roller, the first information being about a voltage value or a current value and the second information being about the opening or closing operation.

### BACKGROUND

### Field of the Technology

The present disclosure relates to an image forming system using an electrophotographic method, an image forming apparatus, and an information processing apparatus.

### Description of the Related Art

In recent years, opportunities for a service contractor to conclude a maintenance or usage-based contract (e.g., a contract where a fee is charged based on the number of pages printed) with a user have been increasing in the market for image forming apparatuses, such as laser printer. Under this type of contract, the unit price per print includes service costs. Therefore, it is important to prevent unnecessary dispatch of a service technician to the user, and in a case where dispatch of a service technician is necessary, it is important to efficiently resolve the failure. Further, in a case where a component requiring replacement can be replaced easily, a user may replace the component. In recent years, opportunities for a user to replace a component have been increasing. Consequently, the possibility of replacement failure is increasing when a user unfamiliar with the replacement work replaces the component. In a case where the user fails to replace the component and a failure occurs, a service technician responsible for maintenance and management needs to visit the user and troubleshoot the failure. In a case where the cause is identified and the service provider notifies the user of an appropriate troubleshooting method, the failure may be resolved by a simple procedure performed by the user. In this case, the service visit may become unnecessary.

Examples of failures that may occur when the user performs the replacement include omitted or defective installation of a unit including a roller that can be attached to and detached from an image forming apparatus (hereinafter, the unit will be referred to as “attachable/detachable unit”) or the roller. To facilitate maintenance of an image forming apparatus, a consumable such as a roller may be provided as an attachable/detachable unit. In this case, a sensor configured to detect installation of the attachable/detachable unit may be provided to prevent omitted or defective installation of the attachable/detachable unit by the user. However, a sensor for detection may not be provided even in a case where a component such as a sheet feeding roller or transfer roller is provided as a component that can be replaced by the user.

Accordingly, Japanese Patent Laid-Open Nos. 2003-208060 and 2004-53637 describe conventional techniques that make it possible to detect the presence or absence of the attachable/detachable unit without installing a sensor configured to detect whether the attachable/detachable unit is installed, thereby preventing omitted or defective installation of the attachable/detachable unit by the user.

### SUMMARY

According to an aspect of the present disclosure, an image forming system includes an image forming apparatus, a notification apparatus configured to notify information, and an information processing apparatus configured to communicate with both the image forming apparatus and the notification apparatus, wherein the image forming apparatus includes a main body, an image bearing member configured to bear a toner image, a transfer roller configured to transfer the toner image on the image bearing member to a transfer material, the transfer roller being configured to be attached to or detached from the main body, a voltage application unit configured to apply a voltage to the transfer roller, a first detection unit configured to detect a voltage value applied to the transfer roller or a current value applied to the transfer roller to which the voltage is applied by the voltage application unit, a door configured to open or close an opening through which the transfer roller is installed or removed, the door being provided to the main body, and a second detection unit configured to detect an opening or closing operation of the door, wherein, in a case where first information changes so as to exceed a threshold between a first point in time and a second point in time after the first point in time and there is an opening or closing log of the door in second information between the first point in time and the second point in time, the information processing apparatus notifies the notification apparatus of information about an installation state of the transfer roller with respect to the main body, the first information being information about the voltage value detected by the first detection unit or the current value detected by the first detection unit and the second information being information about the opening or closing operation of the door detected by the second detection unit.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating an image forming apparatus according to a first embodiment.

FIGS. 2A to 2C are graphs illustrating the relationships between time and each of transfer bias, transfer current, and resistance value of a transfer roller according to the first embodiment.

FIGS. 3A and 3B are diagrams illustrating a transfer roller replacement method according to the first embodiment.

FIG. 4 is a diagram illustrating a criterion used by the determination unit for determination according to the first embodiment.

FIG. 5 is a diagram illustrating a notification system configured to provide a failure notification according to the first embodiment.

FIG. 6 is a flowchart illustrating a flow of notifying a failure determination result according to the first embodiment.

FIG. 7 is a diagram illustrating a notification system configured to provide a failure notification according to a second embodiment.

FIG. 8 is a flowchart illustrating a flow of notifying a failure determination result according to the second embodiment.

FIG. 9 is a diagram illustrating a notification system configured to provide a failure notification according to the second embodiment.

FIG. 10 is a diagram illustrating a notification system configured to provide a failure notification according to a third embodiment.

FIG. 11 is a flowchart illustrating a flow of notifying a failure determination result according to the third embodiment.

FIG. 12 is a diagram illustrating a notification system configured to provide a failure notification according to the third embodiment.

FIG. 13 is a schematic cross-sectional view illustrating an image forming apparatus according to a fourth embodiment.

FIG. 14 is a diagram illustrating a method for replacing a secondary transfer roller according to the fourth embodiment.

FIG. 15 is a diagram illustrating a hardware configuration of each of an image forming apparatus, a server, and a computer according to the first embodiment.

### DESCRIPTION OF THE EMBODIMENTS

### First Embodiment

An image forming apparatus 100 according to the present disclosure and a notification system configured to communicate with the image forming apparatus 100 and operate will be described. An electrophotographic monochrome laser printer will be described as an example of the image forming apparatus 100 according to the present embodiment with reference to the drawings. The present disclosure may be applied to a product that uses an electrophotographic technology, such as a copying machine, and other products.

### Overview of the Image Forming Apparatus

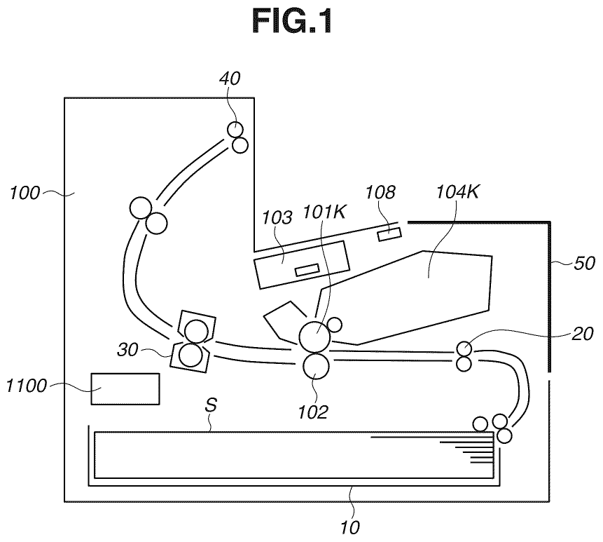

First, a schematic configuration of the monochrome laser printer as the image forming apparatus 100 will be described with reference to FIG. 1. FIG. 1 is a schematic cross-sectional view illustrating the monochrome laser printer using a direct transfer system according to an embodiment of the present disclosure.

First, an image forming unit will be described. The image forming unit includes a photosensitive drum 101K and a transfer roller 102 (e.g., first transfer roller). The photosensitive drum 101K is an image bearing member on which a black toner image is formed and borne on its surface, and the transfer roller 102 faces the photosensitive drum 101K and forms a nip with the photosensitive drum 101K. In the image forming unit, a potential difference is generated between the photosensitive drum 101K and a sheet S (e.g., transfer material), thereby transferring the toner image formed on the photosensitive drum 101K onto the sheet S.

When the image forming unit starts an image forming operation, a laser scanner 103 emits laser light corresponding to an image signal onto the photosensitive drum 101K charged to a fixed potential. The laser light forms an electrostatic latent image on the photosensitive drum 101K. Next, the electrostatic latent image is developed with toner contained in a developing cartridge 104K, thereby forming a toner image (e.g., visible image) on the photosensitive drum 101K. The toner image formed on the photosensitive drum 101K is transferred onto a sheet S fed singly from a container 10. At this time, the position of the sheet S needs to be aligned correctly with respect to the position of the toner image formed on the photosensitive drum 101K in a conveyance direction of the sheet S. Thus, the timing of the sheet S is adjusted by controlling the conveyance speed of registration rollers 20. Then, a bias is applied to the transfer roller 102 at a transfer portion that is the nip formed by the photosensitive drum 101K and the transfer roller 102. This bias transfers the toner image from the photosensitive drum 101K onto the sheet S.

Subsequently, the sheet S with the transferred toner image is conveyed to a fixing device 30 and heated and pressed by the fixing device 30. Consequently, the toner image is fixed to the sheet S. After the toner image is fixed to the sheet S, the sheet S is discharged onto a discharge portion located on an upper portion of the image forming apparatus 100 by a discharge roller pair 40.

The transfer roller 102 is removably held by the main body of the image forming apparatus 100.

Next, control during transfer to which the present embodiment is applied will be described.

### Control During Transfer

When the toner image formed on the photosensitive drum 101K is transferred onto the sheet S at the transfer portion, the bias is applied to the transfer roller 102. At this time, the bias applied to the transfer roller 102 is suitably controlled to match a target current value. By suitably controlling this so-called transfer bias, a favorable transfer image is obtained. In a case where the image forming apparatus 100 performs a print job, the transfer bias is controlled until the toner image formed on the photosensitive drum 101K reaches the transfer portion. Specifically, the transfer bias is controlled based on the target current value by a voltage control unit (not illustrated). In the series of image forming processes, the period from the start of rotation of the photosensitive drum 101K until immediately before the toner image on the photosensitive drum 101K is transferred onto the sheet S, which occurs after the toner image reaches the transfer portion, is defined as “pre-rotation”. The period during which the transfer bias is controlled during the pre-rotation will be referred to as a transfer bias control section.

Further, the pre-rotation operation is a collective term for operations that are performed by components of the image forming unit as preparatory operations for starting the image forming operation after a print job is input. The pre-rotation operations include cleaning the photosensitive drum 101K, adjusting a voltage applied to each processing unit, agitating a developer, heating the fixing device 30, and other operations while rotating the photosensitive drum 101K. Further, the period during which the transfer operation is performed will be referred to as a transfer section.

The transfer bias is controlled based on an instruction from the voltage control unit (not illustrated) during all or part of the transfer bias control section and the transfer section. Specifically, the transfer bias is controlled based on a specified voltage value applied to the transfer roller 102 and a current value detected by a current detection unit (e.g., first detection unit). At this time, the voltage control unit (not illustrated) controls the transfer bias while sequentially changing the transfer bias applied to the transfer roller 102 so that the target current value is achieved. Further, the transfer bias may be controlled based on a resistance value of the transfer roller 102. Specifically, the resistance value of the transfer roller 102 is acquired based on the voltage value applied to the transfer roller 102 and the current value detected by the current detection unit based on an instruction from the voltage control unit (not illustrated). A resistance value R of the transfer roller 102 is calculated from the following formula 1:

R=V/I Formula 1,

where V is the voltage value applied to the transfer roller 102, and I is the detected current value.

According to the present embodiment, a corrected resistance value R′ is calculated by correcting an environmental variation component of the calculated resistance value R so that the effect of the environmental variation is eliminated and a more accurate state of the transfer roller 102 is detected. This correction is performed based on a temperature and humidity detected by an environment sensor of the image forming apparatus 100.

During transfer onto the sheet S, the voltage control unit (not illustrated) controls the transfer bias applied to the transfer roller 102 based on the corrected resistance value R′ so that the current value is adjusted to the target current value.

Next, a method for detecting an installation failure of the transfer roller 102 will be described.

### Method for Detecting an Installation Failure of the Transfer Roller 102

An installation failure of the transfer roller 102 configured to be replaceable, including omitted or defective installation, is detected based on the value of the transfer bias applied to the transfer roller 102. In a case where the transfer roller 102 is not installed, the resistance value of the transfer roller 102 is typically much greater than a normal value in the transfer bias control section. This is caused by a current flowing through another path, if such a path exists, when the transfer roller 102 is not installed. Further, in a case where no other path exists, the resistance value R calculated from formula 1 appears greater than the normal value due to the application of voltage without current flow.

In this case, the voltage value specified by the voltage control unit (not illustrated) to adjust the current value to the target current value is much greater than the normal value. However, an upper limit value is set for the applied voltage value based on the power that can be supplied by a power supply (e.g., a power supply portion 1100 in FIG. 1) of the image forming apparatus 100. Thus, the applied voltage value remains at or below the set upper limit value and does not exceed the upper limit value. Further, the transfer bias is applied in a state where the transfer roller 102 is not installed during the transfer section of toner transfer onto the sheet S. Thus, the transfer bias appears greater than under normal conditions. In other words, the value of the transfer bias is greater when the transfer roller 102 is not installed than when the transfer roller 102 is installed (e.g., normal state). The transfer bias at this time is a value significantly exceeding a normal value range within which a favorable transfer image can be obtained.

Thus, a transfer bias value as a boundary of the normal value range within which a favorable transfer image can be obtained is set as a threshold for the image forming apparatus 100. Accordingly, in a case where the transfer bias exceeds the threshold, the image forming apparatus 100 can detect a state where the transfer roller 102 is not installed or a state where a failure has occurred in the transfer roller 102.

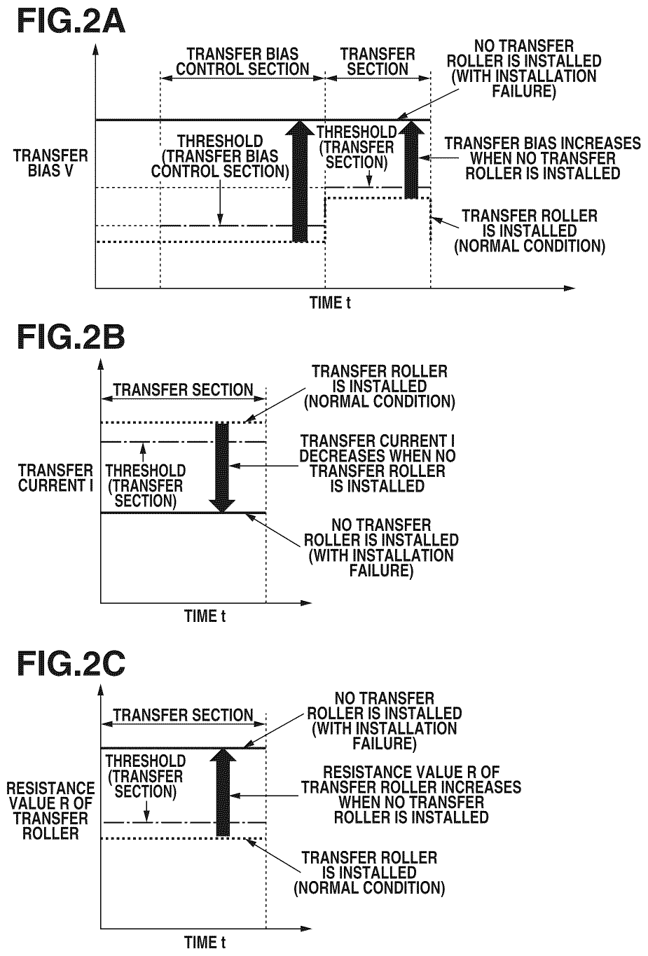

FIG. 2A illustrates transfer bias waveforms during the transfer bias control section and the transfer section for a case where the transfer roller 102 is correctly installed and for a case where the transfer roller 102 is not installed. As illustrated in FIG. 2A, the transfer bias for the case where the transfer roller 102 is not installed exceeds the transfer bias value (e.g., threshold, long dash-dot line), which is set as the boundary within which a favorable transfer image can be obtained, during both the transfer bias control section and the transfer section. In other words, the presence or absence of the transfer roller 102 can be detected at either timing of the transfer bias control section or the transfer section. Further, the threshold may be set to the same or different values for the transfer bias control section and the transfer section. In a case where the threshold is to be set to the same value, the threshold for the transfer bias control section and the threshold for the transfer section are compared, and the threshold is set to the greater of the compared thresholds.

Further, the actual applied voltage value detected by a voltage detection unit (not illustrated) may be used as the transfer bias value. Alternatively, a specified voltage value specified by the voltage control unit (not illustrated) and acquired by a specified voltage value acquisition unit may be used as the transfer bias value.

Further, an indicator other than the transfer bias may be used to detect the presence or absence of the transfer roller 102. The image forming apparatus 100 may be provided with the current detection unit, and a current value detected by the current detection unit may be used for the detection. Alternatively, the resistance value of the transfer roller 102 that is calculated based on the voltage value and the current value may be used for the detection.

FIG. 2B illustrates a case where the current value is used in place of the voltage value. In a case where the transfer roller 102 is not installed, a low current value is observed compared to a normal value range for a case where the transfer roller 102 is installed and a favorable transfer image can be obtained.

FIG. 2C illustrates a case where the resistance value of the transfer roller 102 is used in place of the voltage value. In a case where the transfer roller 102 is not installed, a high resistance value is observed compared to a normal value range for a case where the transfer roller 102 is installed and a favorable transfer image can be obtained.

The above-described cases are based on the assumption that the photosensitive drum 101K, which faces the transfer roller 102 and forms the nip with the transfer roller 102, is correctly set. Thus, a unit configured to detect whether a cartridge is correctly set in the image forming apparatus 100, such as a cartridge presence/absence detection unit, is provided to check whether the photosensitive drum 101K is correctly set.

### Method for Distinguishing Between the Presence or Absence of the Transfer Roller and a Fault in the Power Supply

As described above, it is possible to detect whether the transfer roller 102 is present or absent. However, an abnormal voltage, current, or resistance value of the transfer roller 102 outside the normal value range may also be observed in a state other than the state where the transfer roller 102 is not installed. One possible cause is a fault in the transfer bias power supply.

In other words, identifying whether the cause of the failure responsible for the abnormal value is a fault in the transfer bias power supply or the absence of the transfer roller 102 may improve the accuracy of failure detection for the transfer roller 102. One possible method for improving the accuracy of detecting the presence or absence of the transfer roller 102 is to add detection of whether a typically required operation has been performed prior to the replacement of the transfer roller 102 to the method using the criterion for determining whether the transfer bias has exceeded the normal value.

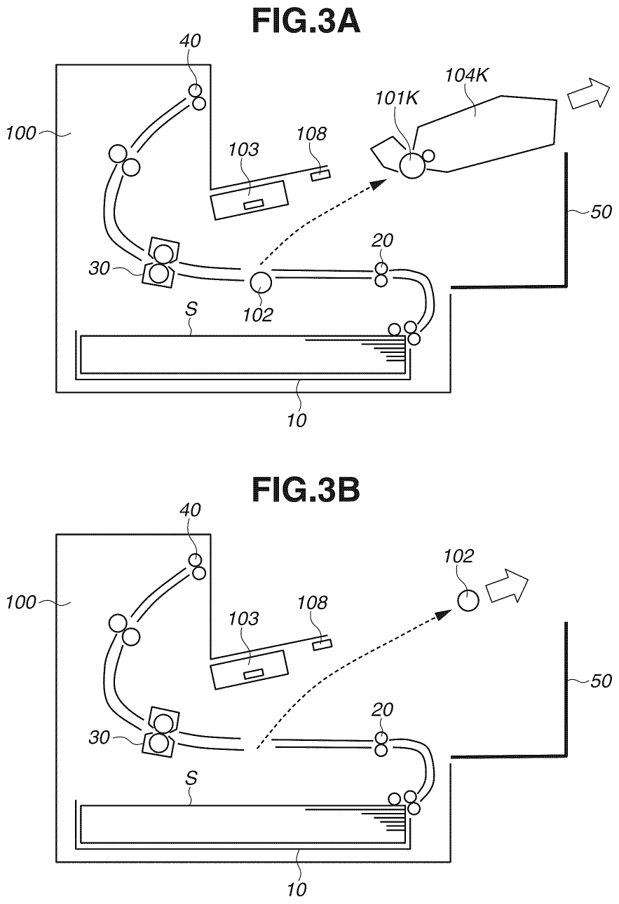

First, a method for replacing the transfer roller 102 of the image forming apparatus 100 according to the present embodiment will be described with reference to FIGS. 3A and 3B. As illustrated in FIG. 3A, first, the user opens a cartridge door 50. Then, the user detaches and removes the developing cartridge 104K from the image forming apparatus 100. Next, as illustrated in FIG. 3B, the user detaches and removes the transfer roller 102 installed in the image forming apparatus 100 from the image forming apparatus 100. Subsequently, the user installs a new transfer roller 102 and a new developing cartridge 104K for replacement in this order in the image forming apparatus 100 following the reverse sequence of the above-described procedure. Then, the user closes the cartridge door 50. This completes the replacement of the transfer roller 102.

Since an opening for removing the transfer roller 102 is typically required to replace the transfer roller 102, the cartridge door 50 needs to be configured so that the user can open and close the cartridge door 50. Thus, the image forming apparatus 100 further includes an opening/closing detection unit 108 (e.g., second detection unit) configured to detect the opening and closing of the cartridge door 50. Furthermore, the image forming apparatus 100 acquires an operation log of the opening/closing detection unit 108. In a case where defective installation or installation failure occurs due to the replacement of the transfer roller 102 by the user, an operation log of the cartridge door 50 detected by the opening/closing detection unit 108 prior to the occurrence is retained.

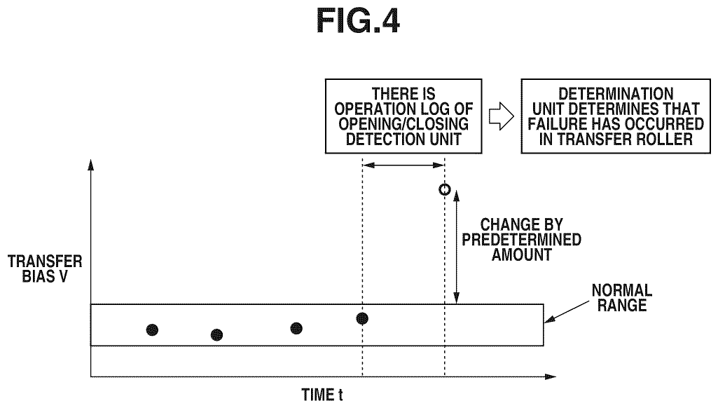

As illustrated in FIG. 4, the possibility of a fault in the transfer bias power supply is determined by a determination unit of the image forming apparatus 100. The determination unit will be described below. There may be no operation log of the opening/closing detection unit 108 between a point in time at which the transfer bias detected by the voltage detection unit (not illustrated) is within the normal range and a point in time at which the transfer bias has changed from the normal range by a predetermined amount (e.g., first threshold). In other words, there may be no operation log (e.g., opening/closing log) of the opening/closing detection unit 108 when a comparison result indicates that the amount of change in the transfer bias is greater than or equal to the first threshold. In this case, the determination unit determines that there is a possibility of a fault in the transfer bias power supply. Further, in a case where a detection result of the transfer bias detected by the voltage detection unit (not illustrated) is within the normal range, the result indicates that the transfer roller 102 is correctly installed in the designated position in the image forming apparatus 100.

However, in a case where the transfer roller 102 is replaced while the main power supply of the image forming apparatus 100 is off, no operation log of the opening/closing unit 50 is retained because the opening/closing detection unit 108 and other components do not operate.

Thus, there may be a circumstance in which there is neither an operation log of the opening/closing detection unit 108 nor an on/off log of the main power supply of the image forming apparatus 100 between the point in time (e.g., first point in time) at which the detected transfer bias is within the normal range and the point in time (e.g., second point in time) at which the detected transfer bias has changed from the normal range by the predetermined amount. In this case, the determination unit determines that there is a possibility of a fault in the transfer bias power supply. This improves the accuracy of detecting the presence or absence of the transfer roller 102. It is evident that the second point in time is after the first point in time and close to the current point in time.

Further, this method for replacing the transfer roller 102 is merely an example, and application to the image forming apparatus 100 that is configured so that the transfer roller 102 can be replaced by simply opening and closing the cartridge door 50 without requiring installation or removal of the developing cartridge 104K.

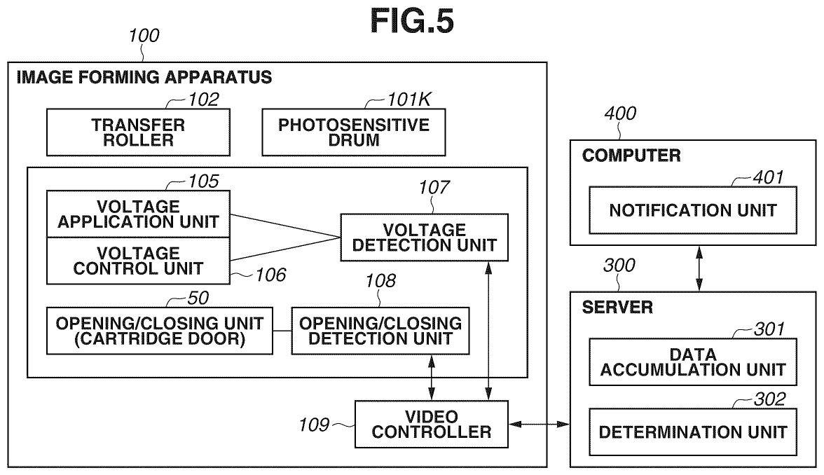

Next, a configuration of the notification system will be described with reference to FIG. 5. The notification system detects an installation failure in the transfer roller 102, including omitted or defective installation, and notifies the detection result to a contractor responsible for printer maintenance and management or an information technology (IT) manager. The notification system includes an image forming apparatus and an information processing apparatus and is also referred to as an image forming system.

### Configuration of the Notification System

As illustrated in FIG. 5, the notification system includes the image forming apparatus 100, a server 300 (e.g., a first processing apparatus that is a first information processing apparatus), and a computer 400 (e.g., a second processing apparatus that is a second information processing apparatus), and the image forming apparatus 100, the server 300, and the computer 400 are connected to communicate with one another via a computer network.

The image forming apparatus 100 includes the transfer roller 102, the photosensitive drum 101K, a voltage application unit 105, a voltage control unit 106, and a voltage detection unit 107. The transfer roller 102 can be installed or removed by the user. The photosensitive drum 101K forms the nip with the transfer roller 102. The voltage application unit 105 applies the transfer bias to the transfer roller 102. The voltage control unit 106 controls the applied voltage. The voltage detection unit 107 detects the voltage value specified by the voltage control unit 106. Further, the image forming apparatus 100 also includes an opening/closing unit 50, the opening/closing detection unit 108, and a video controller 109 (e.g., first communication unit). The opening/closing unit 50 (e.g., or a unit configured to control the cartridge door 50 to be opened or closed, and a drive unit thereof) opens or closes the cartridge door 50 during installation or removal of the transfer roller 102. The opening/closing detection unit 108 detects an opening/closing operation of the opening/closing unit 50. The video controller 109 communicates with the server 300.

The server 300 includes a data accumulation unit 301, a determination unit 302, and a communication unit (e.g., second communication unit). The data accumulation unit 301 accumulates data transmitted from the image forming apparatus 100. The determination unit 302 determines whether there is a failure in the transfer roller 102 based on the accumulated data. The communication unit communicates with an external device.

The computer 400 (e.g., notification apparatus), which is an information processing apparatus, includes a communication unit (e.g., third communication unit) and a display unit (e.g., display) serving as a notification unit 401. The communication unit receives the determination result of the determination unit 302. The notification unit 401 is configured to notify the determination result to a dealer or IT manager.

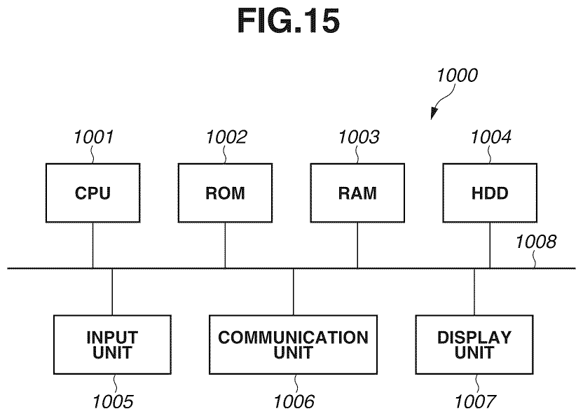

FIG. 15 is a diagram illustrating a hardware configuration of an information processing apparatus 1000, such as the image forming apparatus 100, the server 300, or the computer 400 illustrated in FIG. 5. The configurations of the image forming apparatus 100, the server 300, the computer 400, and other apparatuses illustrated in FIG. 5 include a portion that can be realized by incorporating the information processing apparatus 1000 illustrated in FIG. 15.

A central processing unit (CPU) 1001 performs computation using a program or data stored in a read-only memory (ROM) 1002 or a hard disk drive (HDD) 1004 and controls the entire hardware operation of the image forming apparatus 100, the server 300, and the computer 400.

The ROM 1002 is short for Read Only Memory and is a read-only storage device storing a program and data. A program and data are stored in the ROM 1002 or the HDD 1004 with read/write capability.

A random access memory (RAM) 1003 is short for Random Access Memory and is a temporary storage device.

A program or data is loaded into the RAM 1003 for the CPU 1001 to perform computation.

An input unit 1005 includes a portion configured to receive a user operation input via an external device, such as a mouse or keyboard, convert it into an electrical signal, and transmit the electrical signal. Further, the input unit 1005 of the image forming apparatus 100 also includes a sensor or other component configured to detect a voltage or other element used in computation. A display unit 1007 is a display or other device configured to visually display the computation result of the CPU 1001 to the user. The display unit 1007 of the image forming apparatus 100 may be configured for both input and output, such as a liquid crystal panel. Further, the image forming apparatus 100, the server 300, and the computer 400 may optionally omit the input unit 1005, the display unit 1007, or other components.

A communication unit 1006 is an interface (I/F) configured to transmit the computation result of the CPU 1001 to an external destination. The information processing apparatus 1000, such as the image forming apparatus 100, the server 300, or the computer 400, is connected to one another as illustrated in FIG. 5 via the communication unit 1006.

Further, the CPU 1001, the ROM 1002, the RAM 1003, and other components are connected via a bus 1008 and exchange information with one another in the information processing apparatus 1000 as illustrated in FIG. 15.

With the above-described configuration, information from the sensor serving as the input unit 1005 provided inside the image forming apparatus 100 may be processed, and the processed information may be transmitted from the communication unit 1006 to the server 300. The server 300 may receive the information via the communication unit 1006 of the server 300, and the CPU 1001 of the server 300 may process the information and transmit the processed information to the computer 400 via the communication unit 1006. The computer 400 may receive the information via the communication unit 1006 of the computer 400, and the CPU 1001 of the computer 400 may process the information and display the processed information on the display unit 1007. As described above, the components cooperate to achieve a function so that information of the input unit 1005 of the image forming apparatus 100 is processed and displayed on the display unit 1007 of the computer 400 via the network as illustrated in FIG. 5.

### Determination Result Notification Flow

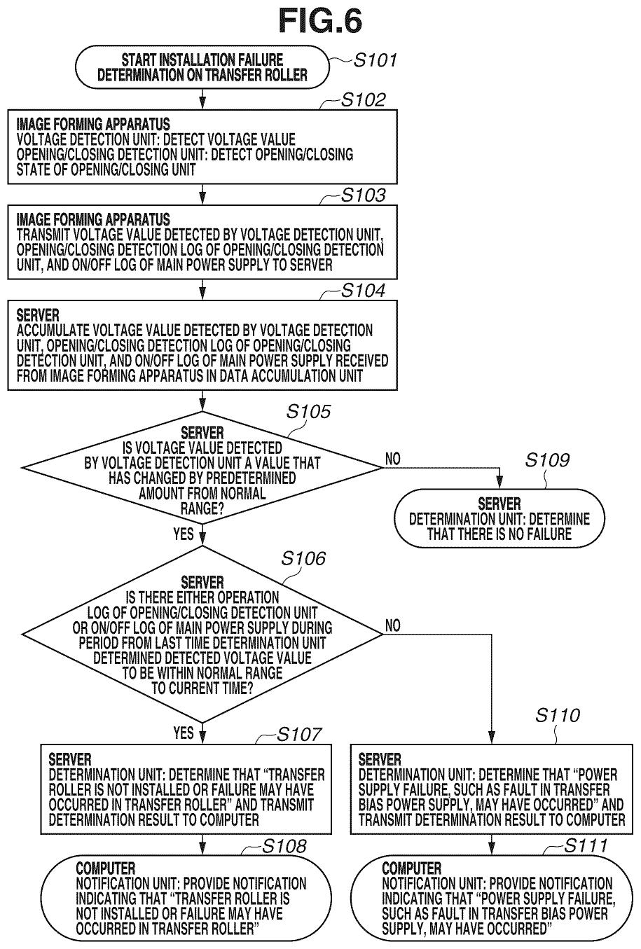

Next, a notification flow from determination of a failure in the transfer roller 102 to notification of the determination result to a third-party dealer or IT manager will be described with reference to FIG. 6.

As illustrated in FIG. 6, first, in step S101, installation failure determination on the transfer roller 102 is started.

The trigger for initiating determination of a failure in the transfer roller 102 may be any of inputting a user operation to start a print job, turning on the main power supply of the image forming apparatus 100, or detecting an operation to close the cartridge door 50. In step S102, as described above, the voltage detection unit 107 of the image forming apparatus 100 detects the transfer bias (e.g., voltage value) applied to the transfer roller 102 during pre-rotation or image formation, and the opening/closing detection unit 108 of the image forming apparatus 100 detects an opening or closing operation of the cartridge door 50.

In step S103, the voltage value detected by the voltage detection unit 107, the opening/closing detection log of the cartridge door 50 detected by the opening/closing detection unit 108, and the on/off log of the main power supply of the image forming apparatus 100 are transmitted to the server 300.

In step S104, the server 300 accumulates the voltage value, the opening/closing detection log, and the on/off log of the main power supply (e.g., these are collectively referred to as accumulation data) received from the image forming apparatus 100 in the data accumulation unit 301. The data accumulation unit 301 corresponds to the RAM 1003 and the HDD 1004 illustrated in FIG. 15. The server 300 acquires the on/off log of the main power supply based on the communication state with the image forming apparatus 100 (e.g., the communication unit 1006 of the server 300 serves as a third detection unit).

In step S105, the determination unit 302 of the server 300 determines whether the latest accumulated voltage value (e.g., first information) in the data accumulation unit 301 is a value that has changed from the normal value range (e.g., reference value) by the predetermined amount. The determination unit 302 corresponds to the CPU 1001 illustrated in FIG. 15.

In a case where the determination unit 302 determines that the voltage value is not a value that has changed by the predetermined amount (NO in step S105), in step S109, it is determined that there is no failure in the transfer roller 102, and the flow is terminated.

On the other hand, in a case where the determination unit 302 determines that the voltage value is a value that has changed from the reference value by the predetermined amount (YES in step S105), in step S106, the determination unit 302 performs determination on the period from the last time the determination unit 302 determined that the voltage value was not a value that had changed from the reference value by the predetermined amount to the current time. Specifically, the determination unit 302 determines whether there is either an operation log (e.g., second information) of the cartridge door 50 detected by the opening/closing detection unit 108 or an on/off log (e.g., third information) of the main power supply during the period.

In a case where there is either an operation log of the cartridge door 50 detected by the opening/closing detection unit 108 or an on/off log of the main power supply (YES in step S106), in step S107, the determination unit 302 makes a determination. Specifically, the determination unit 302 determines that “the transfer roller 102 is not installed or a failure may have occurred in the transfer roller 102” and transmits information about the determination result as status information to the computer 400, which is an information processing apparatus.

In step S108, after receiving the determination result, the computer 400 displays information, such as “the transfer roller 102 is not installed or a failure may have occurred in the transfer roller 102”, on the display unit (e.g., display) serving as the notification unit 401. This display serves as notification to the dealer or IT manager.

On the other hand, in a case where there is neither an operation log of the cartridge door 50 detected by the opening/closing detection unit 108 nor an on/off log of the main power supply (NO in step S106), in step S110, the determination unit 302 determines that “a power supply failure, such as a fault in the transfer bias power supply, may have occurred” and transmits the determination result to the computer 400, which is an information processing apparatus. Then, in step S111, after receiving the determination result, the computer 400 displays information, such as “a power supply failure, such as a fault in the transfer bias power supply, may have occurred”, on the display unit (e.g., display) serving as the notification unit 401. This display serves as notification to the dealer or IT manager.

Further, the computer 400 to which the determination result is transmitted from the server 300 is not limited to a computer for maintenance and management that is managed by a third-party dealer or IT manager. In other words, the user may set a notification destination (e.g., to the dealer or IT manager, the user).

This will be described with reference to FIG. 15. The setting input by the user is transmitted to the CPU 1001 via the input unit 1005 and undergoes computation, and the result is stored in the HDD 1004.

Thereafter, the setting is retrieved when it may be needed, and the CPU 1001 determines the notification destination based on the setting and performs a process of transmitting information to be displayed on the display unit 1007 from the communication unit 1006.

A graphical user interface (GUI) used by the user to configure the setting may be configured so that the computer 400 to which the server 300 transmits the determination result can be selected from a pull-down menu. For example, a notification system may be established that displays the computer for maintenance and management that is managed by the dealer or IT manager, a user management computer managed by the user, and both as options and prompts the user to make a selection.

Furthermore, the image forming apparatus 100 may include a display unit (e.g., operation panel) configured to serve as the notification unit 401. The image forming apparatus 100 receives the determination result (e.g., fourth information) from the server 300, and the determination result is processed by the information processing apparatus 1000, which is illustrated in FIG. 15, in the image forming apparatus 100 and displayed on the display unit 1007. When the user views the displayed information, the notification is completed.

Further, the voltage value used to detect an installation failure in the transfer roller 102, including omitted or defective installation, may be the current value or the resistance value of the transfer roller 102, as described above.

With the above-described configuration, a failure notification is provided to the user when the transfer roller 102 configured to be installed in or removed from the image forming apparatus 100 is replaced by the user. For example, an image defect may occur due to omitted or defective installation of the transfer roller 102 by the user. In this case, the determination unit can notify the dealer responsible for maintenance and management that the failure originates from the transfer roller 102.

Based on this notification, the dealer responsible for maintenance and management can remotely notify the user of a procedure for resolving the improper state and prompt the user to follow the procedure without dispatching a service. This may resolve the failure encountered by the user. The dealer responsible for maintenance and management can appropriately determine whether a service dispatch is probably required, which makes it possible to reduce an unnecessary dispatch to the user. Further, the dealer can realize improved efficiency, such as a reduction in service time. Consequently, a reduction in service cost is also realized. Furthermore, a failure in the transfer roller 102 can be notified to the user without requiring dealer intervention. This makes it possible to resolve the failure within a shorter period, which contributes to resolving user dissatisfaction. In addition, service costs incurred by the dealer responsible for maintenance and management are also reduced.

### Second Embodiment

Next, a second embodiment will be described, focusing on the differences from the first embodiment.

According to the second embodiment, the configuration of the notification system does not include the server 300, and the image forming apparatus 100 includes the determination unit 302.

### Configuration of the Notification System

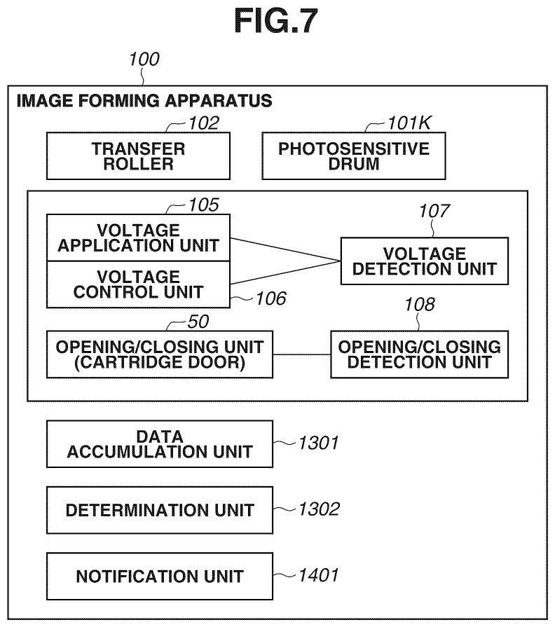

The notification system will be described with reference to FIG. 7. As illustrated in FIG. 7, the notification system includes only the image forming apparatus 100.

The image forming apparatus 100 includes the transfer roller 102, the photosensitive drum 101K, the voltage application unit 105, the voltage control unit 106, the voltage detection unit 107, the opening/closing unit (e.g., the cartridge door 50), and the opening/closing detection unit 108. The transfer roller 102 can be installed or removed by the user. The photosensitive drum 101K forms the nip with the transfer roller 102. The voltage application unit 105 applies the transfer bias to the transfer roller 102. The voltage control unit 106 controls the applied voltage. The voltage detection unit 107 detects the voltage value specified by the voltage control unit 106. The opening/closing unit needs to be opened or closed during installation or removal of the transfer roller 102. The opening/closing detection unit 108 detects an opening/closing operation of the opening/closing unit 50. The image forming apparatus 100 further includes a data accumulation unit 1301, a determination unit 1302, and a display unit (e.g., operation panel) serving as a notification unit 1401. The data accumulation unit 1301 accumulates data. The determination unit 1302 determines whether there is a failure in the transfer roller 102 based on the data accumulated in the data accumulation unit 1301. The notification unit 1401 notifies the determination result of the determination unit 1302 to the user.

### Determination Result Notification Flow

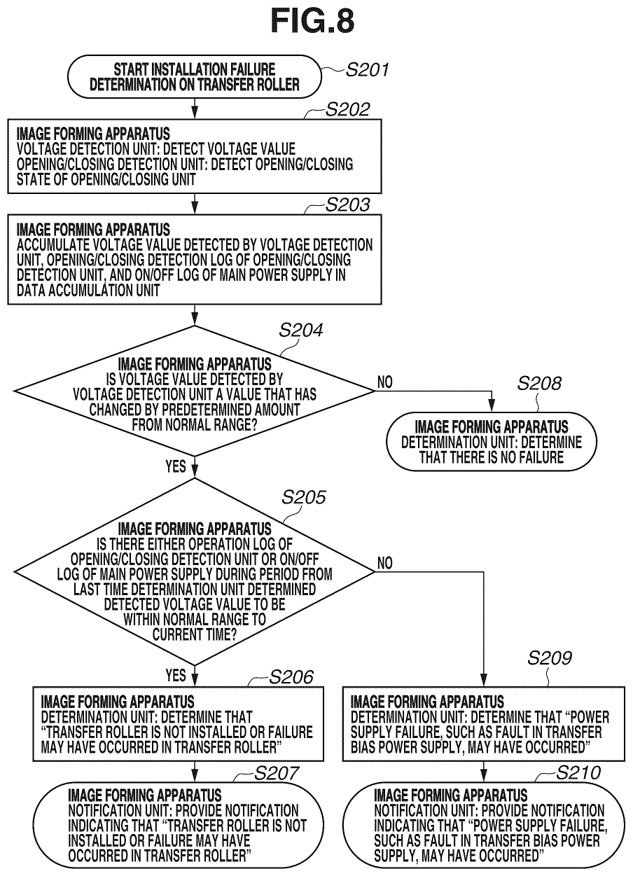

Next, a notification flow from determination of a failure in the transfer roller 102, including omitted or defective installation, to notification of the determination result to the user will be described with reference to FIG. 8.

As illustrated in FIG. 8, in step S201, installation failure determination on the transfer roller 102 is started. The trigger for initiating determination of a failure in the transfer roller 102 may be any of inputting a user operation to start a print job, turning on the main power supply of the image forming apparatus 100, or detecting an operation to close the cartridge door 50.

In step S202, as described above, the voltage detection unit 107 of the image forming apparatus 100 detects the transfer bias value applied to the transfer roller 102 during pre-rotation or image formation, and the opening/closing detection unit 108 of the image forming apparatus 100 detects opening or closing of the cartridge door 50.

In step S203, the voltage value detected by the voltage detection unit 107, the opening/closing detection log of the cartridge door 50 detected by the opening/closing detection unit 108, and the on/off log of the main power supply of the image forming apparatus 100 are accumulated in the data accumulation unit 1301. The data accumulation unit 1301 corresponds to the HDD 1004 or another component illustrated in FIG. 15.

In step S204, the determination unit 1302 of the image forming apparatus 100 determines whether the latest accumulated voltage value in the data accumulation unit 1301 is a value that has changed from the normal value range (e.g., reference value) by the predetermined amount. The determination performed by the determination unit 1302 corresponds to the computation performed by the CPU 1001 of the information processing apparatus 1000 of the image forming apparatus 100 illustrated in FIG. 15.

In a case where the determination unit 1302 determines that the voltage value is not a value that has changed from the reference value by the predetermined amount (NO in step S204), in step S208, it is determined that there is no failure in the transfer roller 102 or the transfer bias power supply, and the flow is terminated.

On the other hand, in a case where the determination unit 1302 determines that the voltage value is a value that has changed from the reference value by the predetermined amount (YES in step S204), in step S205, the determination unit 1302 performs a determination process. Specifically, the determination unit 1302 determines whether there is either an operation log of the cartridge door 50 detected by the opening/closing detection unit 108 or an on/off log of the main power supply during the period from the last time the determination unit 1302 determined that the voltage value was not a value that had changed from the reference value by the predetermined amount to the current time.

In a case where there is either an operation log of the cartridge door 50 detected by the opening/closing detection unit 108 or an on/off log of the main power supply (YES in step S205), in step S206, the determination unit 1302 determines that “the transfer roller 102 is not installed or a failure may have occurred in the transfer roller 102”.

Then, in step S207, a notification is provided to the user using the display unit (e.g., operation panel) serving as the notification unit 1401 of the image forming apparatus 100 according to the present embodiment. Specifically, information such as “the transfer roller 102 is not installed or a failure may have occurred in the transfer roller 102” is displayed, thereby providing a notification to the user.

On the other hand, in a case where there is neither an operation log of the cartridge door 50 detected by the opening/closing detection unit 108 nor an on/off log of the main power supply (NO in step S205), in step S209, the determination unit 1302 determines that “a power supply failure, such as a fault in the transfer bias power supply, may have occurred”.

Then, in step S210, the display unit (e.g., operation panel) serving as the notification unit 1401 of the image forming apparatus 100 displays information such as “a power supply failure, such as a fault in the transfer bias power supply, may have occurred”, thereby providing a notification to the user.

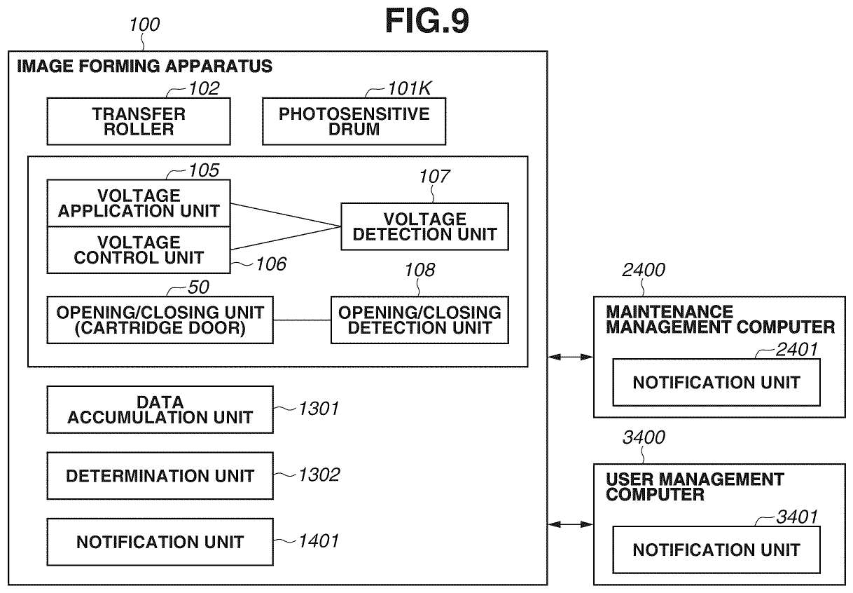

Further, the determination result of the determination unit 1302 of the image forming apparatus 100 is not limited to being displayed on the display unit serving as the notification unit 1401 of the image forming apparatus 100. In other words, as illustrated in FIG. 9, the determination result of the determination unit 1302 of the image forming apparatus 100 may be transmitted. In other words, the information is transmitted to a maintenance management computer 2400 managed by the dealer or IT manager and/or a user management computer 3400 managed by the user. Based on the transmitted information, display units 2401 and 3401 serving as notification units 2401 and 3401 of the computers 2400 and 3400 display the determination result. As described above, the notification may be provided to the dealer or IT manager and the user located at a physically separate site from the image forming apparatus 100.

In this case, as illustrated in FIG. 15, the CPU 1001 of the information processing apparatus 1000 of the image forming apparatus 100 performs processes up to the determination process, and the communication unit 1006 transmits the determination result as information to an external destination. Further, each of the maintenance management computer 2400 and the user management computer 3400 managed by the user includes the information processing apparatus 1000. In the information processing apparatus 1000 illustrated in FIG. 15, the communication unit 1006 receives the determination result and transmits the determination result to the CPU 1001, and the display unit 1007 performs displaying as described above based on an instruction from the CPU 1001.

It should be noted that the voltage value used to detect an installation failure in the transfer roller 102 may be the current value or the resistance value of the transfer roller 102, as described above.

With the above-described configuration, it is not necessary to build a large-scale notification system using the server 300 or the cloud. By simply preparing a system that includes only the image forming apparatus 100 or a system in which the image forming apparatus 100 and the computers 2400 and 3400 are connected either via a local area network (LAN) or directly, the user can achieve an effect similar to that of the first embodiment. Specifically, omitted or defective installation of the transfer roller 102 caused by the user is detected, and a notification of the determination result is provided to the dealer and/or the user. This makes it possible to resolve the failure within a shorter period, which contributes to resolving user dissatisfaction promptly. In addition, service costs incurred by the dealer responsible for maintenance and management are also reduced.

### Third Embodiment

Next, a third embodiment will be described, focusing on the differences from the first embodiment.

According to the third embodiment, the configuration of the notification system does not include the server 300, and a determination unit 4302 is not provided to the image forming apparatus 100. Further, the determination unit 4302 is provided to a computer 4400 in the notification system.

### Configuration of the Notification System

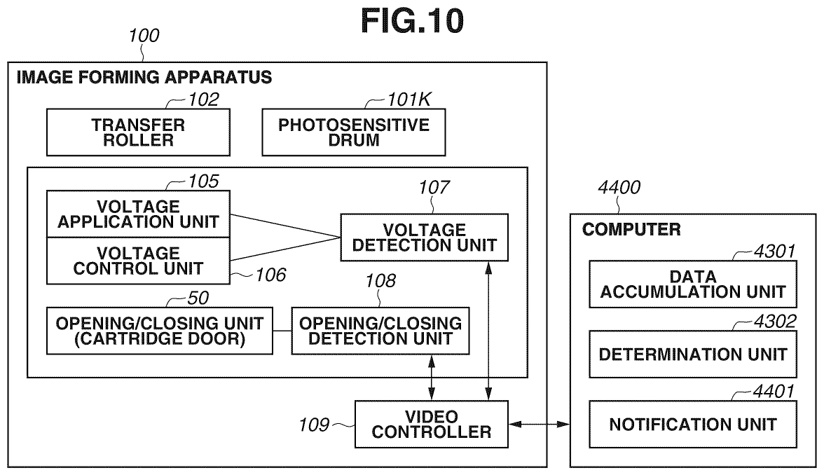

The notification system will be described with reference to FIG. 10. As illustrated in FIG. 10, the notification system includes the image forming apparatus 100 and the computer 4400. The image forming apparatus 100 includes the transfer roller 102 and the photosensitive drum 101K. The transfer roller 102 can be installed or removed by the user. The photosensitive drum 101K forms the nip with the transfer roller 102. Further, the image forming apparatus 100 includes the voltage application unit 105 and the voltage control unit 106. The voltage application unit 105 applies the transfer bias to the transfer roller 102. The voltage control unit 106 controls the applied voltage. Furthermore, the image forming apparatus 100 includes the voltage detection unit 107. The voltage detection unit 107 detects the voltage value specified by the voltage control unit 106.

The image forming apparatus 100 further includes the opening/closing unit (e.g., the cartridge door 50), the opening/closing detection unit 108, and the video controller 109. The opening/closing unit needs to be opened or closed during installation or removal of the transfer roller 102. The opening/closing detection unit 108 detects an opening/closing operation of the opening/closing unit 50. The video controller 109 communicates with the computer 4400, which is an information processing unit. Each of the image forming apparatus 100 and the computer 4400 includes the configuration of the information processing apparatus 1000 illustrated in FIG. 15, and these units are partly realized by the hardware configuration illustrated in FIG. 15.

The computer 4400 includes a data accumulation unit 4301 and the determination unit 4302. The data accumulation unit 4301 accumulates data transmitted from the image forming apparatus 100. The determination unit 4302 determines whether there is a failure in the transfer roller 102 based on the accumulated data. The data accumulation unit 4301 corresponds to the HDD 1004 or other component illustrated in FIG. 15, and the determination unit 4302 corresponds to the CPU 1001 illustrated in FIG. 15.

The computer 4400 includes a display unit (e.g., display) serving as a notification unit 4401 configured to notify the determination result of the determination unit 4302 to the dealer, the IT manager, and/or the user. The computer 4400 includes the configuration of the information processing apparatus 1000 illustrated in FIG. 15, and the display unit of the computer 4400 corresponds to the display unit 1007 illustrated in FIG. 15.

### Determination Result Notification Flow

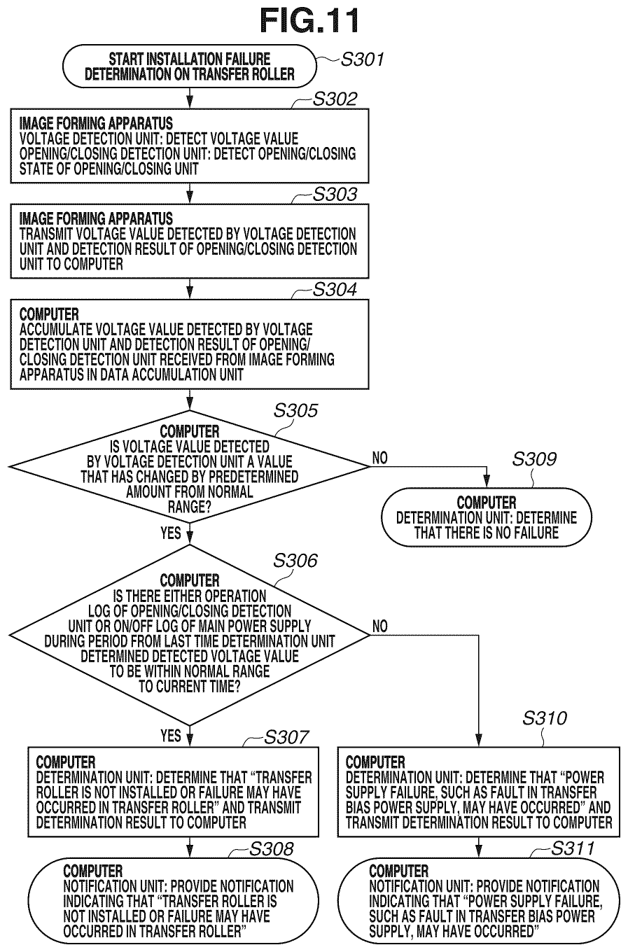

Next, a notification flow from determination of a failure in the transfer roller 102, including omitted or defective installation, to notification of the determination result to the user will be described with reference to FIG. 11.

As illustrated in FIG. 11, first, in step S301, installation failure determination on the transfer roller 102 is started.

The trigger for initiating determination of a failure in the transfer roller 102 may be any of inputting a user operation to start a print job, turning on the main power supply of the image forming apparatus 100, or detecting an operation to close the cartridge door 50. In step S302, as described above, the image forming apparatus 100 detects the transfer bias (e.g., voltage value) applied to the transfer roller 102 by the voltage detection unit 107 during pre-rotation or image formation. Further, the opening/closing detection unit 108 detects opening or closing of the cartridge door 50.

In step S303, the voltage value detected by the voltage detection unit 107, the opening/closing detection log of the cartridge door 50 detected by the opening/closing detection unit 108, and the on/off log of the main power supply of the image forming apparatus 100 are transmitted to the computer 4400.

In step S304, the computer 4400 accumulates the voltage value received from the image forming apparatus 100, the opening/closing detection log, and the on/off log of the main power supply in the data accumulation unit 4301. The data accumulation unit 4301 corresponds to the HDD 1004 or another component illustrated in FIG. 15.

In step S305, the determination unit 4302 of the computer 4400 determines whether the latest accumulated voltage value in the data accumulation unit 4301 is a value that has changed from the normal value range (e.g., reference value) by the predetermined amount. The determination unit 4302 corresponds to the CPU 1001 illustrated in FIG. 15.

In a case where the determination unit 4302 determines that the voltage value is not a value that has changed from the reference value by the predetermined amount (NO in step S305), in step S309, it is determined that there is no failure in the transfer roller 102 or the transfer bias power supply, and the flow is terminated.

On the other hand, in a case where the determination unit 4302 determines that the voltage value is a value that has changed from the reference value by the predetermined amount (YES in step S305), in step S306, the determination unit 4302 performs the following determination. Specifically, the determination unit 4302 determines whether there is either an operation log of the cartridge door 50 detected by the opening/closing detection unit 108 or an on/off log of the main power supply during the period from the last time the determination unit 4302 determined that the voltage value was not a value that had changed from the reference value by the predetermined amount to the current time.

In a case where there is either an operation log of the cartridge door 50 detected by the opening/closing detection unit 108 or an on/off log of the main power supply (YES in step S306), in step S307, the determination unit 4302 determines that “the transfer roller 102 is not installed or a failure may have occurred in the transfer roller 102”. Then, the determination unit 4302 transmits the determination result to the computer 4400, which is an information processing apparatus.

Then, in step S308, after receiving the determination result, the computer 4400 displays the received information on the display unit (e.g., operation panel) serving as the notification unit 4401. Specifically, the computer 4400 displays information, such as “the transfer roller 102 is not installed or a failure may have occurred in the transfer roller 102”. This serves as notification to the dealer, the IT manager, the user, and/or other destinations.

On the other hand, in a case where there is neither an operation log of the cartridge door 50 detected by the opening/closing detection unit 108 nor an on/off log of the main power supply (NO in step S306), in step S310, the determination unit 4302 determines that “a power supply failure, such as a fault in the transfer bias power supply, may have occurred”. This determination result is transmitted to the computer 4400, which is an information processing apparatus.

Then, in step S311, information, such as “a power supply failure, such as a fault in the transfer bias power supply, may have occurred”, is displayed on the display unit (e.g., operation panel) of the image forming apparatus 100. This serves as notification to the dealer, the IT manager, and/or the user.

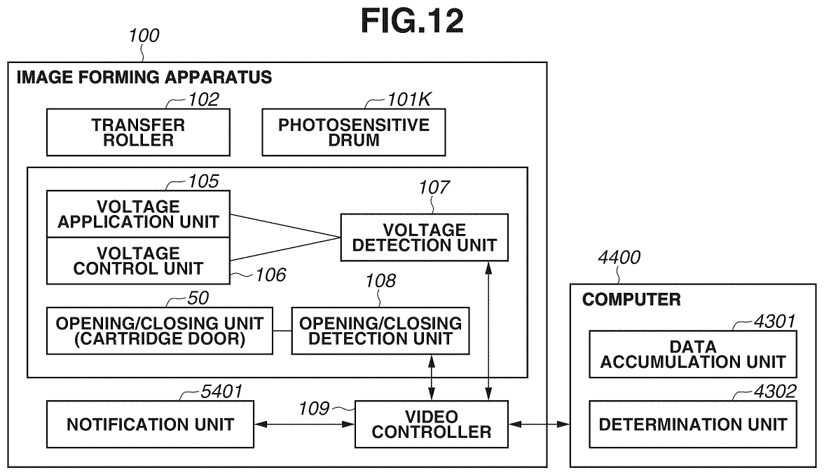

As illustrated in FIG. 12, the image forming apparatus 100 includes the display unit (e.g., operation panel) serving as the notification unit 4401. The image forming apparatus 100 receives the determination result of the information processing apparatus (e.g., the computer 4400) via the video controller 109 of the image forming apparatus 100.

As described above, the image forming apparatus 100 may notify the user of the determination result by displaying the determination result on the display unit (e.g., operation panel).

Further, the notification unit 4401 may be provided to each of the image forming apparatus 100 and the computer 4400, and a notification of the determination result may be provided by both of the notification units 4401.

The voltage value used to detect an installation failure in the transfer roller 102, including omitted or defective installation, may be the current value or the resistance value of the transfer roller 102, as described above.

With the above-described configuration, even in a case where the image forming apparatus 100 does not include the determination unit 4302, the notification system as a whole can detect a failure. The computer 4400 configured to communicate with the image forming apparatus 100 determines whether omitted or defective installation of the transfer roller 102 caused by the user has occurred, and the determination result is notified to the dealer, the user, and/or other destinations.

This makes it possible to resolve the failure within a shorter period, which contributes to resolving user dissatisfaction.

In addition, service costs incurred by the dealer responsible for maintenance and management are also reduced.

### Fourth Embodiment

Next, a fourth embodiment will be described, focusing on the differences from the first embodiment.

An image forming apparatus to which the fourth embodiment is applied uses an intermediate transfer method, and detection of the presence or absence is performed for a secondary transfer roller 202.

### Overview of the Image Forming Apparatus Using the Intermediate Transfer Method

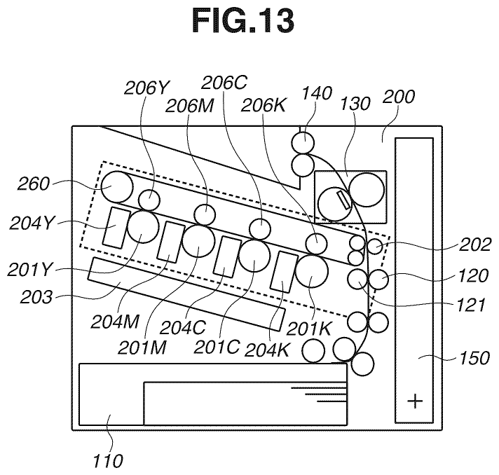

A schematic configuration of an image forming apparatus 200 using the intermediate transfer method will be described with reference to FIG. 13. FIG. 13 is a schematic cross-sectional view illustrating the image forming apparatus 200 using the intermediate transfer method according to an embodiment of the present disclosure.

First, an image forming unit will be described. The image forming unit is provided to a main body of the image forming apparatus 200 and forms an image using an electrophotographic method. The image forming unit includes four photosensitive drums 201Y, 201M, 201C, and 201K on which yellow, magenta, cyan, and black toner images are formed. Further, the image forming unit includes an intermediate transfer belt 260. The intermediate transfer belt 260 is an endless belt and is brought into contact with the four photosensitive drums 201Y, 201M, 201C, and 201K, and toner images formed on the four photosensitive drums 201Y, 201M, 201C, and 201K are primarily transferred onto the intermediate transfer belt 260. The intermediate transfer belt 260 is rotatably supported by a plurality of stretching rollers. Further, the image forming unit includes primary transfer rollers 206Y, 206M, 206C, and 206K. The primary transfer rollers 206Y, 206M, 206C, and 206K form nips with respect to the photosensitive drums 201Y, 201M, 201C, and 201K from the inner periphery side of the intermediate transfer belt 260 and generates potential differences between the photosensitive drums 201Y, 201M, 201C, and 201K and the intermediate transfer belt 260, thereby primarily transferring the toner images. Further, the image forming unit includes the secondary transfer roller 202 (e.g., second transfer roller). The secondary transfer roller 202 forms a nip with the outer periphery side of the intermediate transfer belt 260 and secondarily transfers the transferred images on the intermediate transfer belt 260 onto a sheet S.

Once the image forming unit starts an image forming operation, a laser scanner 203 emits laser light corresponding to an image signal to the photosensitive drums 201Y, 201M, 201C, and 201K charged to the fixed potential. Then, electrostatic latent images are formed on the photosensitive drums 201Y, 201M, 201C, and 201K. Next, the electrostatic latent images are developed with toners contained in developing cartridges 204Y, 204M, 204C, and 204K. Consequently, toner images (e.g., visible images) are formed on the photosensitive drums 201Y, 201M, 201C, and 201K. Next, the toner images formed on the photosensitive drums 201Y, 201M, 201C, and 201K are primarily transferred onto the intermediate transfer belt 260. Then, the toner images on the intermediate transfer belt 260 after the primary transfer are conveyed to a secondary transfer portion by the intermediate transfer belt 260.

In parallel with the toner image forming operation, the sheet S is singly fed from a container 110. The sheet S is conveyed to the secondary transfer portion by registration rollers 120 and 121 configured to perform skew correction. The secondary transfer portion is formed at the nip between the intermediate transfer belt 260 and the secondary transfer roller 202. At this time, the position of the sheet S in the sheet conveyance direction needs to be aligned with the toner images formed on the intermediate transfer belt 260. Thus, the timing between the sheet S and the toner images is adjusted by controlling the conveyance speed of the registration roller 120. Then, the bias is applied to the secondary transfer roller 202 at the secondary transfer portion, thereby transferring the toner images from the intermediate transfer belt 260 onto the sheet S. The sheet S with the transferred toner images is subsequently conveyed to a fixing unit 130. The fixing unit 130 applies heat and pressure, thereby fixing the toner images to the sheet S. After this fixing process, the sheet S is discharged onto a discharge unit located on an upper portion of the image forming apparatus 200 by a discharge roller pair 140.

### Control During Secondary Transfer

When the toner images formed on the intermediate transfer belt 260 are transferred onto the sheet S at the secondary transfer portion, the bias is applied to the secondary transfer roller 202. At this time, the bias applied to the secondary transfer roller 202 is appropriately controlled so that a target current value is achieved. As a result, a favorable transferred image is obtained. When a print job (e.g., image forming job) is performed, the voltage control unit 106 controls a transfer voltage based on the target current value before the toner images formed on the photosensitive drums 201Y, 201M, 201C, and 201K reach the transfer portion. In the series of image forming processes, the period from the start of rotation of the photosensitive drums 201Y, 201M, 201C, and 201K until immediately before the transfer of the toner images onto the sheet S at the secondary transfer portion is started is defined as “pre-rotation”. During pre-rotation, the voltage control unit 106 performs transfer voltage control at the secondary transfer portion. As a result, the secondary transfer voltage is controlled so that the current that flows at the secondary transfer portion is adjusted to the target current value during image formation.

### Method for Detecting an Installation Failure of the Secondary Transfer Roller

An installation failure of the secondary transfer roller 202, including omitted or defective installation, is detected in the same manner as that for the transfer roller 102 according to the first embodiment. The installation failure detection for the transfer roller 102 according to the first embodiment is based on the assumption that the photosensitive drum 101K, which faces the transfer roller 102 and forms the nip with the transfer roller 102, is correctly set. Thus, a unit configured to detect the presence or absence of a cartridge to check whether the photosensitive drum 101K is correctly set is required. The installation failure detection for the secondary transfer roller 202 according to the present embodiment is based on the assumption that the intermediate transfer belt 260, which faces the secondary transfer roller 202 and forms the nip with the secondary transfer roller 202, is correctly set. Thus, a unit configured to check whether the intermediate transfer belt 260 is correctly set by detecting the presence or absence of the intermediate transfer belt 260 is provided.

### Method for Distinguishing Between the Presence or Absence of the Secondary Transfer Roller and a Fault in the Power Supply

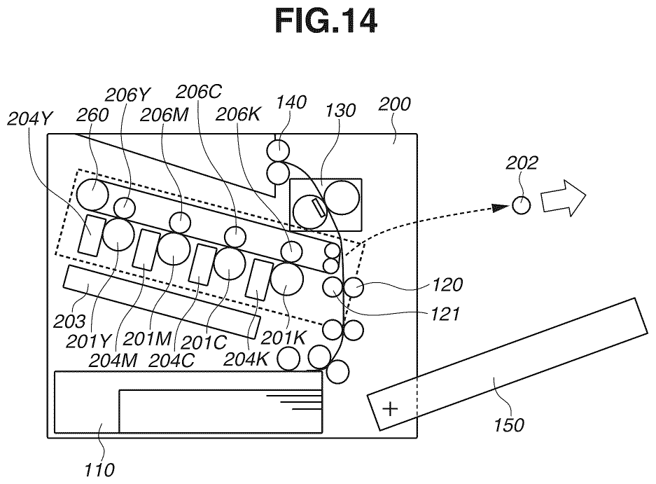

As in the first embodiment, a distinction is made between a fault in the transfer bias power supply and the absence of the secondary transfer roller 202. This improves the accuracy of detecting the presence or absence of the secondary transfer roller 202. In the method for improving the accuracy of detecting the presence or absence of the secondary transfer roller 202, the criterion for determining whether the transfer bias has exceeded the normal value is used. Further, in this method, the detection result indicating whether an operation that can replace the secondary transfer roller 202 has been performed is added. A method for replacing the secondary transfer roller 202 of the image forming apparatus 200 according to the present embodiment will be described with reference to FIG. 14. As illustrated in FIG. 14, a right door 150 is opened, and the secondary transfer roller 202 is removed from the image forming apparatus 200. An opening/closing detection log of the right door 150 is used in place of the cartridge door 50 according to the first embodiment. This distinguishes between a fault in the transfer bias power supply and an installation failure of the secondary transfer roller 202, including omitted or defective installation, as in the first embodiment.

As described above, the image forming apparatus 200 (e.g., so-called color image forming apparatus) using the intermediate transfer method is also configured to detect omitted or defective installation of the transfer roller 202 caused by an erroneous operation by the user and appropriately notify the detection result to the dealer and/or the user.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-013042, filed Jan. 29, 2025, which is hereby incorporated by reference herein in its entirety.

What is claimed is:

1. An image forming system comprising:
an image forming apparatus;
a notification apparatus configured to notify information; and
an information processing apparatus configured to communicate with both the image forming apparatus and the notification apparatus,
wherein the image forming apparatus includes:
a main body;
an image bearing member configured to bear a toner image;
a transfer roller configured to transfer the toner image on the image bearing member to a transfer material, the transfer roller being configured to be attached to or detached from the main body;
a voltage application unit configured to apply a voltage to the transfer roller;
a first detection unit configured to detect a voltage value applied to the transfer roller or a current value applied to the transfer roller to which the voltage is applied by the voltage application unit;
a door configured to open or close an opening through which the transfer roller is installed or removed, the door being provided to the main body; and
a second detection unit configured to detect an opening or closing operation of the door,
wherein, in a case where first information changes so as to exceed a threshold between a first point in time and a second point in time after the first point in time and there is an opening or closing log of the door in second information between the first point in time and the second point in time, the information processing apparatus notifies the notification apparatus of information about an installation state of the transfer roller with respect to the main body, the first information being information about the voltage value detected by the first detection unit or the current value detected by the first detection unit and the second information being information about the opening or closing operation of the door detected by the second detection unit.

2. The image forming system according to claim 1,
wherein the image forming apparatus further includes a third detection unit configured to detect an on/off log of a power supply of the main body,
wherein, in a case where the first information changes so as to exceed the threshold between the first point in time and the second point in time after the first point in time and there is no opening or closing log of the door in the second information between the first point in time and the second point in time, when the on/off log exists in third information between the first point in time and the second point in time, the information processing apparatus notifies the notification apparatus of the information about the installation state of the transfer roller with respect to the main body, the third information being information about the on/off log of the power supply detected by the third detection unit, and
wherein, in a case where the first information changes so as to exceed the threshold between the first point in time and the second point in time after the first point in time and there is no opening or closing log of the door in the second information between the first point in time and the second point in time, when the on/off log does not exist in the third information between the first point in time and the second point in time, the information processing apparatus does not notify the notification apparatus of the information about the installation state of the transfer roller with respect to the main body.

3. The image forming system according to claim 1,
wherein the image bearing member is a photosensitive drum, and
wherein the transfer roller transfers the toner image on the photosensitive drum to the transfer material.

4. The image forming system according to claim 1,
wherein the image forming apparatus further includes:
a photosensitive drum configured to bear the toner image;
a belt being an endless belt stretched by a plurality of rollers and configured to rotate; and
a first transfer roller configured to transfer the toner image borne on the photosensitive drum to the belt,
wherein a second transfer roller transfers the transferred toner image on the belt to the transfer material, the transfer roller being the second transfer roller.

5. The image forming system according to claim 1, wherein the image forming apparatus further includes a notification unit configured to notify the information about the installation state of the transfer roller with respect to the main body in a case where the first information changes so as to exceed the threshold at the second point in time after the first point in time and there is the opening or closing log of the door in the second information between the first point in time and the second point in time.

6. The image forming system according to claim 2, wherein the image forming apparatus further includes a notification unit configured to notify the information about the installation state of the transfer roller with respect to the main body when the on/off log exists in the third information between the first point in time and the second point in time in a case where the first information changes so as to exceed the threshold at the second point in time after the first point in time and there is no opening or closing log of the door in the second information between the first point in time and the second point in time.

7. An image forming apparatus comprising:
a main body;
an image bearing member configured to bear a toner image;
a transfer roller configured to transfer the toner image on the image bearing member to a transfer material, the transfer roller being configured to be attached to or detached from the main body;
a voltage application unit configured to apply a voltage to the transfer roller;
a first detection unit configured to detect a voltage value applied to the transfer roller or a current value applied to the transfer roller to which the voltage is applied by the voltage application unit;
a door configured to open or close an opening through which the transfer roller is installed or removed, the door being provided to the main body;
a second detection unit configured to detect an opening or closing operation of the door; and
a notification unit configured to notify information about an installation state of the transfer roller with respect to the main body in a case where first information changes so as to exceed a threshold between a first point in time and a second point in time after the first point in time and there is an opening or closing log of the door in second information between the first point in time and the second point in time, the first information being information about the voltage value detected by the first detection unit or the current value detected by the first detection unit and the second information being information about the opening or closing operation of the door detected by the second detection unit.

8. The image forming apparatus according to claim 7, further comprising a third detection unit configured to detect an on/off log of a power supply of the main body,
wherein, in a case where the first information changes so as to exceed the threshold between the first point in time and the second point in time after the first point in time and there is no opening or closing log of the door in the second information between the first point in time and the second point in time, when the on/off log exists in third information between the first point in time and the second point in time, the notification unit notifies the information about the installation state of the transfer roller with respect to the main body, the third information being information about the on/off log of the power supply detected by the third detection unit, and
wherein, in a case where the first information changes so as to exceed the threshold between the first point in time and the second point in time after the first point in time and there is no opening or closing log of the door in the second information between the first point in time and the second point in time, when the on/off log does not exist in the third information between the first point in time and the second point in time, the notification unit does not notify the information about the installation state of the transfer roller with respect to the main body.

9. An information processing apparatus that communicates with both an image forming apparatus and a notification apparatus that notifies information, the image forming apparatus comprising:
a main body;
an image bearing member configured to bear a toner image;
a transfer roller configured to transfer the toner image on the image bearing member to a transfer material, the transfer roller being configured to be attached to or detached from the main body;
a voltage application unit configured to apply a voltage to the transfer roller;
a first detection unit configured to detect a voltage value applied to the transfer roller or a current value applied to the transfer roller to which the voltage is applied by the voltage application unit;
a door configured to open or close an opening through which the transfer roller is installed or removed, the door being provided to the main body; and
a second detection unit configured to detect an opening or closing operation of the door,
wherein, in a case where first information changes so as to exceed a threshold between a first point in time and a second point in time after the first point in time and there is an opening or closing log of the door in second information between the first point in time and the second point in time, the information processing apparatus notifies the notification apparatus of information about an installation state of the transfer roller with respect to the main body, the first information being information about the voltage value detected by the first detection unit or the current value detected by the first detection unit and the second information being information about the opening or closing operation of the door detected by the second detection unit.

10. The information processing apparatus according to claim 9,
wherein the image forming apparatus further includes a third detection unit configured to detect an on/off log of a power supply of the main body, and
wherein, in a case where the first information changes so as to exceed the threshold between the first point in time and the second point in time after the first point in time and there is no opening or closing log of the door in the second information between the first point in time and the second point in time, when the on/off log exists in third information between the first point in time and the second point in time, the information processing apparatus notifies the notification apparatus of the information about the installation state of the transfer roller with respect to the main body, the third information being information about the on/off log of the power supply detected by the third detection unit, and
wherein in a case where the first information changes so as to exceed the threshold between the first point in time and the second point in time after the first point in time and there is no opening or closing log of the door in the second information between the first point in time and the second point in time, when the on/off log does not exist in the third information between the first point in time and the second point in time, the information processing apparatus does not notify the notification apparatus of the information about the installation state of the transfer roller with respect to the main body.
